(19) United States
(12) Patent Application Publication
(10) Pub. No.: US 2009/0107365 A1
(43) Pub. Date: Apr. 30, 2009

(54) APPARATUS AND SYSTEMS FOR CONVERTING TABLE HEIGHT, METHODS FOR USING AND MAKING SAME

(75) Inventors: Glenn Felterman, Ft. Smith, AR (US); Scott Ostrander, Ft. Smith, AR (US); Fred Henjes, Kennett Square, PA (US); Danuel McGatha, Van Buren, AR (US)

Correspondence Address: GILBRETH & ASSOCIATES, P.C., PO BOX 2428, BELLAIRE, TX, 77402-2428, US

(73) Assignee: Riverside Furniture Corporation, Fort Smith, AR (US)

(21) Appl. No.: 11/923,642

(22) Filed: Oct. 24, 2007

(51) Int. Cl. A47B 9/00; A47B 96/14; A47B 81/00; G06Q 30/00

(52) U.S. Cl. 108/107; 108/186; 312/234; 705/26

(57) ABSTRACT

Tables convertible between a first and at least a second height. Tables comprise a base having a body and legs, a tabletop supported by the base, and at least one height extension piece attached either removably or permanently to either the base, the tabletop, or both.

### BACKGROUND

1. Technical Field

The present disclosure relates generally to furniture components, furniture, and to methods of making, modifying and/or using same. In another aspect, the present invention relates to furniture having a flat surface, and to methods of making, modifying and/or using same. In even another aspect, the present invention relates to furniture in which the height of the furniture may be adjusted, and to methods of making and/or using same. In still another aspect, the present invention relates to table components, to tables, and to methods of making and/or using same. In yet another aspect, the present invention relates to multipurpose furniture, and even more particularly to multipurpose furniture suitable for use at least as a variety of different types of tables.

2. Background Information

A variety of tables are known in the art. While a conventional table may provide a user with a tabletop having a set/fixed height, many times a table of varying height for a variety of uses is desired. While one could buy a table at each desired height, such an approach may not be practical.

Adjustable height tables do exist in the art. For example, there are tables with telescoping legs, however, these tables clearly look adjustable to the causal observer, which some believe detracts from the style and look of the table. Also, these tables generally have some give or play in stability because of give/play in the telescoping legs. Mechanically adjustable tables and/or hydraulically adjustable tables have also been described in the art.

In spite of advancements in the art, a table base that is convertible between a number of heights has not been described. Thus, there is a need in the art for tables that convert from one height to another.

These and other needs in the art will become apparent to those of skill in the art upon review of this specification, including its drawings and claims.

### SUMMARY

The following presents a general summary of some of the many possible embodiments of this disclosure in order to provide a basic understanding of this disclosure. This summary is not an extensive overview of all embodiments of the disclosure. This summary is not intended to identify key or critical elements of the disclosure or to delineate or otherwise limit the scope of the claims. The following summary merely presents some concepts of the disclosure in a general form as a prelude to the more detailed description that follows.

According to one non-limiting embodiment there is provided an apparatus comprising a table base, a tabletop supported by said base, and at least one height extension piece removably attached to the base.

According to another non-limiting embodiment there is provided a system comprising a table base, a tabletop supported by said base, and a set of interchangeable height adjustment members.

According to even another non-limiting embodiment there is provided a method for converting the height of a table comprising the steps of removably attaching at least one height extension piece to a table base to create a height-extended base, and removably attaching a tabletop atop said extended base.

According to still another non-limiting embodiment there is provided a method for converting the height of a table from a first height to a second height comprising the step of removing a first height extension piece of a first length from the table.

According to yet another non-limiting embodiment there is provided a method for converting the height of a table comprising the steps of removing a first height extension piece of a first length from the table, and attaching a second height extension piece of a second length in its place converting the table from a first height to a second height.

According to even yet another embodiment of the present invention there is provided a table sales system comprising at least one display table unit on display in a display area and a sales stock comprising at least one reserve table base unit and at least one reserve height extension piece.

According to still yet another embodiment of the present invention, there is provided a method for processing an order. The method may include receiving order for a table of a first description. The method may also include filling the order with a base unit table and the necessary height extension piece to correspond to description.

Other embodiments are contained within the following description and will become apparent to those of skill in the art upon review of the description and drawings.

### BRIEF DESCRIPTION OF THE DRAWINGS

The following drawings illustrate some of the many possible embodiments of the present disclosure in order to provide a basic understanding of the disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 shows one non-limiting table of the disclosure.

FIG. 2 illustrates a non-limiting method for attachment of the tabletop and table base of the table in FIG. 1.

FIG. 3 illustrates a non-limiting method for assembly of base leg hardware of the table in FIG. 1.

FIG. 4 illustrates a non-limiting method for attaching a height extension piece to a table base.

FIG. 5 illustrates a non-limiting method for attaching the tabletop to a table base comprising height extension pieces.

FIG. 6 shows the table of FIG. 1 further comprising height extension pieces.

FIGS. 7A, 7B and 7C provide cross section front, plan and top elevation views of a non-limiting table of the disclosure.

FIG. 8 is a cross section front elevation view of a non-limiting table of the disclosure.

FIG. 9 shows both cross section front and top elevation views of a non-limiting table base leg showing attachment of a height extension piece.

FIG. 10 shows both cross section front and top elevation views of a non-limiting table base leg with a height extension piece attached.

### DETAILED DESCRIPTION

The present disclosure provides tables that are convertible with respect to height, especially the height of the tabletop. The present disclosure further provides methods for converting a table having a tabletop at a first height to at least a second height. Depending on the table top height selected by a user, the present tables are well suited for any number of a variety of uses including, but not limited to, a dining table, a gathering table, a work table, a general purpose table, an entertainment table, a sofa table, a coffee table, a cocktail table, an end table, and a living room table. The present tables may also be suitable in those applications in which a multiplicity of heights may be desirable, non-limiting examples of which include classroom settings, nursing homes, hospitals, work environments, and the like. The listed uses are for example purposes only and are not intended to limit the scope of the present disclosure.

Generally the apparatus and systems of the present disclosure comprise a tabletop supported by a table base and at least one removable and/or exchangable height extension member/piece removably attached to the table base. In one non-limiting method of the disclosure a table may be converted from a first height (H1) to a second height (H2) by removably attaching at least one height extension piece (which increases the table height by an amount of X) to the table base. The second height is equal to the first height plus the length/height of the extension piece which may be expressed as “H2=(H1+X).” All measurements discussed herein are given in inches unless otherwise indicated. The extension piece may be held in position by any means known in the art so long as the piece is securely positioned on or to the table base and may be removed when so desired.

The present invention provides methods for adjusting/converting the height of a table from a first height to at least a second height, wherein the first height is less than the second height. Generally the method comprises the step of attaching at least one height extension piece to the table in order to raise the height of the table. The table may or may not comprise a previously attached height extension piece prior to the performing the step of attaching.

The present invention further provides methods for adjusting the height of the table from a first height to at least a second height, wherein the first height is greater than the second height. Generally the method comprises the step of removing a height extension piece from the table in order to reduce the height of the table. The table may comprise two or more height extension pieces attached in tandem. The step of removing a height extension piece from the table may comprise removing one or more of the tandemly attached height extension pieces.

The present invention even further provides methods for adjusting the height of a table from a first height to a second height by exchanging/replacing a first height extension piece having a first extension height for a second height extension piece having a second extension height. In some embodiments, the first extension height is greater than the second extension height (i.e., X1 is greater than X2) and the table height is decreased/lowered by exchanging the first extension piece for the second extension piece. In other embodiments, the first extension height is less than the second extension height (i.e., X1 is less than X2) in which case the table height is increased/raised by exchanging the first extension piece for the second extension piece.

In all methods of the present disclosure wherein one or more height extension pieces are attached to a table, any one or more methods may comprise the step of selecting a height extension piece from among a set or subset of height extension pieces each having either a different height extension value (i.e., X1 does not equal X2 does not equal X3, etc), a different shape, a different exterior finish/design, or any combinations thereof. Any one or more methods may comprise permanently attaching or permanently removing one or more height extension pieces thereby permanently adjusting the height of the table.

The apparatus, systems of methods of the present disclosure are suitable for a variety of areas such as but not limited to manufacturing and/or sales.

In a manufacturing embodiment, a manufacturer might produce a base unit at a base height, and a multiplicity of height extension pieces of one or more height extension values. The manufacturer may then easily accommodate different retail orders for different Stock Keeping Units (SKUs) by adding one or more height extension pieces to the base unit. Examples of different SKUs that a US retailer might request include but are by no means limited to a standard US dining table height, a standard US gathering table height, and a standard US pub or bar height. The multiplicity of height extension pieces may differ in any one or more of the following: height extension value, shape, exterior finish, design, and any and all combinations thereof.

Thus, the present disclosure still further provides methods for manufacturing tables based on a base unit. Generally the method comprises receiving an order for a table having a height greater than the base unit. The method may further comprise adding a height extension piece to the base unit to produce the desired height of table. The manufacturer may ship to the retailer a table with the suitable extension piece attached to the table, or a boxed or packaged system which the ultimate consumer would purchase wherein the system may include the base unit and any number of height extension pieces. On the other hand, the manufacturer may ship the retailer base units and free standing height extension pieces, which the retailer may mix and match as desired per sales requests.

The present disclosure yet further provides methods for wholesaling/retailing tables. In one embodiment, a seller may easily fill wholesale/retail customer orders based on display of one or more units at one or more heights. The display unit/s may be at any height.

Such a wholesale/retail method for processing an order may include receiving order for a table of a certain description. The method may also include filling the order with a base unit table and the necessary height extension piece to correspond to description. Very commonly today, goods are provided a unique Stock Keeping Unit (SKU) number. So, in other embodiments, the table may be ordered by SKU number as the description.

Any part or all of the methods of the present invention may be computer implemented. For example, the order processing may be carried out by computer, with the order automatically taken via the internet, phone, text message or any other type of communication. The order may then be automatically filled by computer controlled equipment which will either assemble and/or box the base and required extension piece.

Generally a table sales system for the wholesale/retail establishment comprises at least one display unit (to preserve showroom floor-space/shelf-space) on display, and a sales stock comprising at least one reserve base unit and at least one reserve height extension piece. In various embodiments the table sales system includes at least 1, 2, 3, 4, 5, 6, 7, 8, 9, 10, 15, 20, 30, or 40 reserve base units and/or reserve height extension units. The display unit, which may or may not include an extension piece, may be on display such as on a showroom or display floor, and one or more reserve units are either adjacent the display, away from the display in nearby storage, and/or at remote storage. When a customer places an order for one or more units at one or more heights, the retailer may modify a reserve unit by the addition of height extension pieces, if modification to the base unit is necessary to accommodate the customer's request. Some portion or all of the sales stock may be located adjacent the display unit in the display area, perhaps in a cabinet or one a shelf, and may or may not be packaged/assembled. Some portion or all of sales stock may also be located somewhat apart from the display unit in a storeroom or warehouse. Certainly, some wholesale/retail establishments may have sales stock adjacent the display unit, in storage/warehouse space in proximity to the display are, and/or remote storage/warehouse space.

With respect to the height extension members/pieces of the present diclosure, some embodiments contemplate a single extension piece which is either in position or not, and other embodiments contemplate a set of extension pieces, any one of which may be in place or not. The apparatus and systems of the disclosure may comprise a set of interchangable height extension pieces comprising at least two or more members having the same length dimension. It should be noted that the number of height extension pieces necessary to support the table above the base will depend upon the number of connection points between the base and the table top. For example, a table with 4 legs may have four connections points between the table top and the base, or may have only one. The apparatus and systems of the disclosure may comprise a set of height extension pieces comprising a plurality of subsets wherein each of the subsets differ from one another with respect to their length dimension, shape, and/or finish. For example, while the members/pieces of a subset all have the same X value (X being the amount by which they increase the height of table when in position), each subset may have a different X value. Certainly, there may be subsets of different shapes and/or finish. As a non-limiting example, members of a first subset may add 6 inches to a table height when in position, members of a second subset may add 8 inches to a table height when in position, members of a third subset may add 10 inches to a table height when in position, members of a fourth subset may add 12 inches to a table height when in position, etc. It should be understood that any heights (X values) may be utilized for the extension pieces of the disclosure. In the US domestic market, a 6 inch extension may be commonly utilized, as that is the height needed to convert a standard dining table to one of “gathering” table height, and also the height needed to convert a gathering table height to that of a pub or bar table. In some embodiments, two or more members of the same or different subsets may be attached to a table in tandem thereby combining the amount by which they increase the table's height. In addition, the set of extension pieces may comprise members having the same or any number of different cross sectional shapes. Thus, while two or more subsets may have the same height, they may differ in shape, surface finish/texture, and/or color.

Generally the height extension piece is removably attached to the table base and will support the tabletop. In one embodiment, the height extension piece is positioned between the table base and the tabletop. Other embodiments contemplate placing the extension piece between the floor and the table, for example at the bottom of the legs of a table base, and even other embodiments contemplate extension pieces which may be inserted into the table legs, that is, between two pieces of a table leg. In one embodiment, a height extension piece is affixed to the top of each leg of the table base to create an extended table base having extended legs. The tabletop may then be attached to the extended base. The connection between the height extension pieces and the base, and the height extension pieces and the tabletop may be by any means known in the art including but not limited to any fastener known in the art, bolts, screws, pegs, pins, straps, interlocking fasteners, clasps, buckles, snaps, dowels, biscuits, splines, staples, nails, friction fit, and all combinations thereof. While the height extension piece may be removably connected, some embodiments contemplate permanently securing the height extension piece in place to permanently convert the table to a second height.

Tabletops suitable for use herein may be any style of tabletop known in the art including but not limited to tabletops comprising one or more drop leaves, tabletops with one or more removable table leaves or sections, tabletops that are adjustable with respect to position and/or size, and tabletops having a fixed size and/or vertical position. Generally the tabletops are supported by a table base of the disclosure. The tabletop may be held in position atop the table base by any means known in the art including but not limited to any fastener known in the art, bolts, screws, pegs, pins, straps, interlocking fasteners, clasps, buckles, snaps, dowels, biscuits, splines, staples, nails, friction fit, and all combinations thereof. Preferably the tabletops are removably positioned atop the table base thereby providing ease of height conversion.

The table bases of the present disclosure may be any style or type of table base known in the art and may comprise any number of legs. Suitable table bases include but are not limited to pedestal style bases comprising one or more pedestal foot/leg, a tripod style base comprising three legs, a table base comprising four legs stabilized and/or connected by stretchers, a cabinet style table base, and any table base with more than four legs, to give but a few examples.

With respect to height, generally the tables of the disclosure are convertible between at least a first height and a second height. The tables of the disclosure may be convertible from a first height to any number of additional heights. Generally the heights are in the range of from about 12 to about 60 inches. Certainly, the market place will prefer some heights over others, with the US, European, and Asian markets having specific requirements, perhaps even varying by country and/or region. In the US domestic market, for one embodiment, the tables are convertible between at least two heights both in the range of 18 and 56 inches tall. In another embodiment, the tables of the disclosure are convertible between at least two heights both in the range of 24 and 52 inches tall. In even another embodiment, the tables of the disclosure are convertible between at least two heights both in the range of 28 and 42 inches tall. In one non-limiting embodiment, the tables have a first height of about 30 inches equal to that of a conventional dining table and may be converted to a second height of about 36 inches equal to that of a gathering height table, and/or to a third height of 42 inches equal to that of a pub table or bar table.

With respect to length of the articles of the present disclosure, in one embodiment, the tabletops of the tables of the disclosure have a length between 12 and 120 inches. In another embodiment, the tabletops have a length between 18 and 72 inches. In even another embodiment, the tabletops have a length between 24 and 60 inches. In still another embodiment, the tabletops have a length between 30 and 55 inches. As known in the art, the length of a table may be expanded by insertion of at least one table leaf, and tables of the disclosure may comprise one or more insertable table leaf.

With respect to depth, in one embodiment, the articles of the disclosure are of a depth between 12 and 60 inches. In another embodiment, the articles are of a depth between 18 and 56 inches. In even another embodiment, the articles are of a depth between 22 and 52 inches.

The cross sectional shape of each of the table base, the tabletop, and the height extension members may be any shape such as but not limited to rectangular, square, oval, round, triangular, and any regular or irregular geometric shape. The table base, the table top and the height extension members may be the same or different shapes. The figures of the present disclosure illustrate one non-limiting embodiment comprising a tabletop, table base and height extension pieces each having a square cross sectional shape.

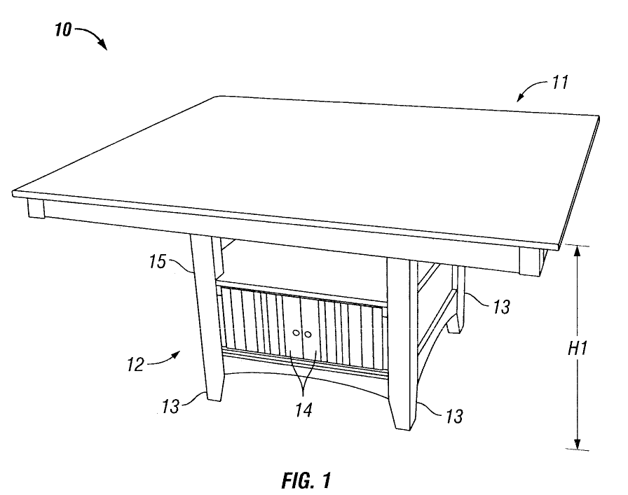

Referring now to FIG. 1, there is illustrated non-limiting article 10 of the disclosure. Article 10 comprises tabletop 11 and table base 12. Table base 12 is a cabinet style table base comprising a box shaped body having left and right side/end panels, a back panel, a front, and a top and bottom panel. As used herein, terms such as “top”, “bottom”, “left”, “right”, “back” and “front” are from the perspective of an individual positioned in front of and facing the length of an article of the disclosure. Table base 12 further comprises four base legs 13. The front panel of base 12 has pair of doors 14 attached thereto. Concealed by pair of doors 14 and defined by the body panels of base 12 is an interior storage compartment. Top panel 15 of base 12 provides a surface/shelf area onto which items may be placed. Article 10 has height H1 as indicated in FIG. 1 and H1 is equal to 30 inches. Tabletop 11 of non-limiting article 10 is 48 inches in both length and depth, and comprises at least one insertable table leaf (not shown) having a width of 18 inches. Thus, when the table leaf is inserted into tabletop 11, tabletop 11 is expanded to a length of 66 inches.

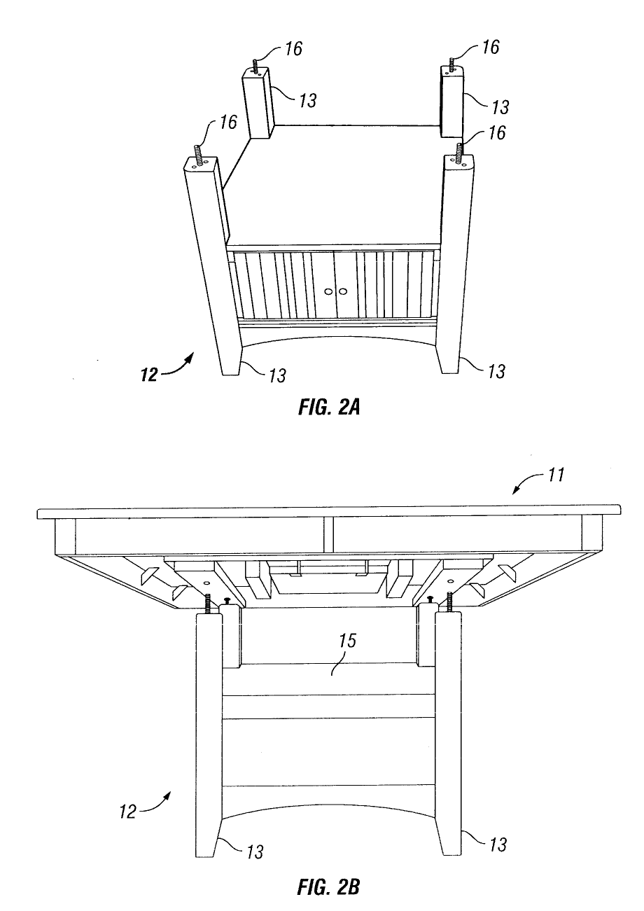

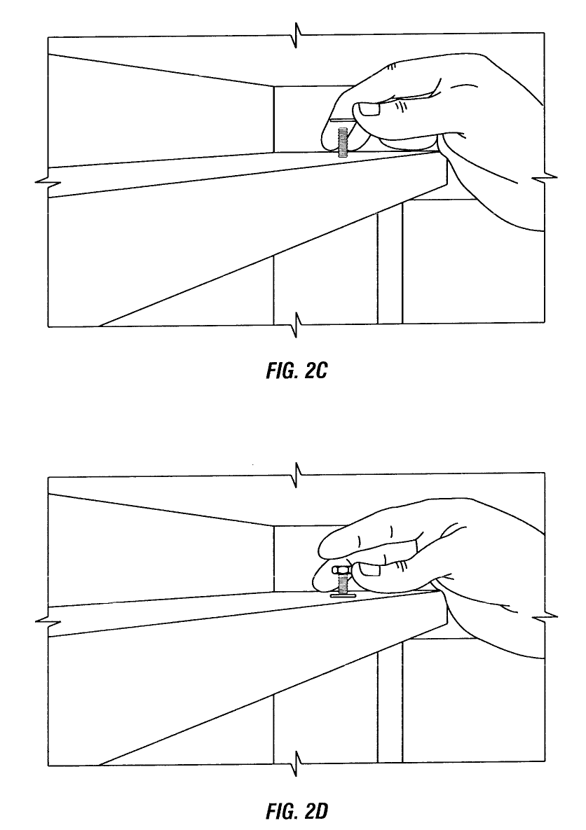

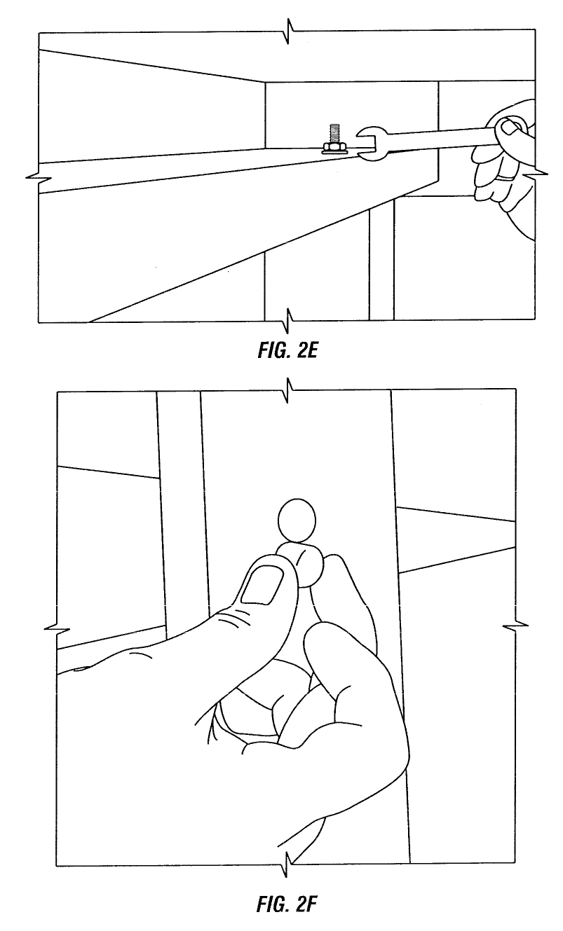

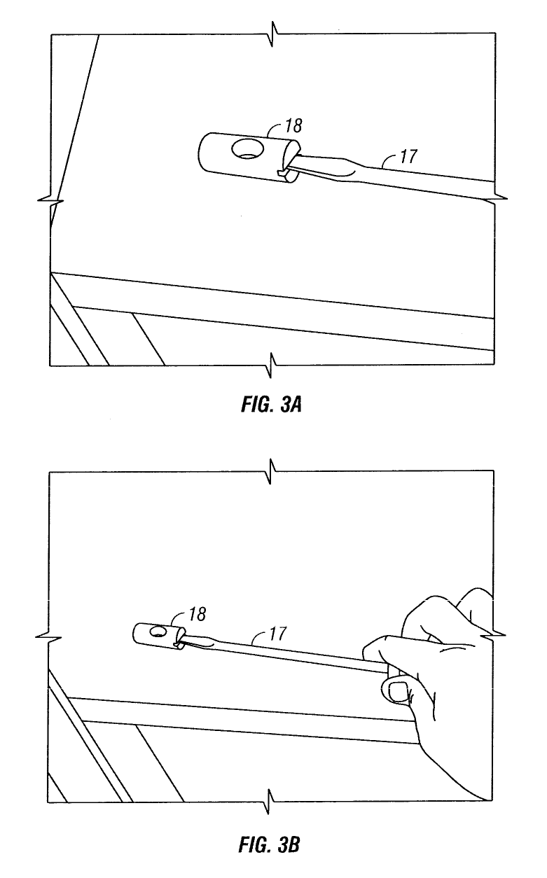

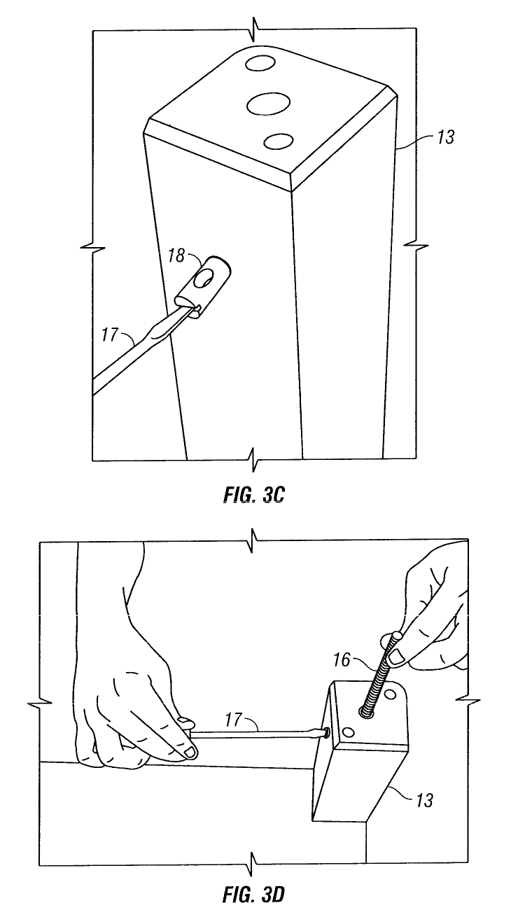

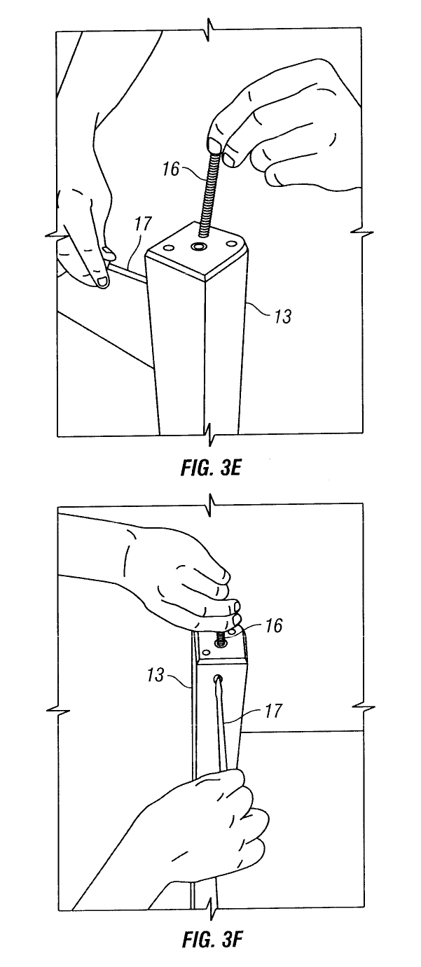

Referring now to FIGS. 2 and 3, there is depicted one non-limiting method of the disclosure for affixing tabletop 11 to base 12 by connecting the tabletop to the top of each base leg 13. FIG. 2A shows base 12 without a tabletop attached, wherein each base leg 13 has one all thread 16 extending therefrom. Tabletop 11 may then installed onto base 12 by aligning attachment holes in tabletop 11 with each all thread 16, shown in FIG. 2B. Tabletop 11 may then be secured to base 12 by any means known in the art. Shown in FIGS. 3C through 3E, a washer may be placed over each all thread 16, followed by attachment of a nut onto each all thread 16.

FIG. 3 illustrates one non-limiting method of the disclosure by which each all thread 16 may be fitted into each base leg 13. As shown in FIGS. 3A and 3B, a tool such as flathead screwdriver 17 may be inserted into one end of and used to hold joint connector nut 18. Joint connector nut 18 may be inserted into a first receiving hole in one side of base leg 13, shown in FIG. 3C. All thread 16 may then be inserted into a second receiving hole on the top of base leg 13, shown in FIG. 3D. All thread 16 may then be properly aligned with and screwed into joint connector nut 18, until securely tightened, shown in FIGS. 3D and 3E. The method illustrated in FIGS. 3A through 3E may be repeated for each base leg 13, indicated by FIG. 3F. As known by one of skill in the art, any visible receiving holes may be filled or plugged. FIG. 2F shows insertion of wooden plug 21 into a first receiving hole in one base leg 13. Generally the plugs are removable.

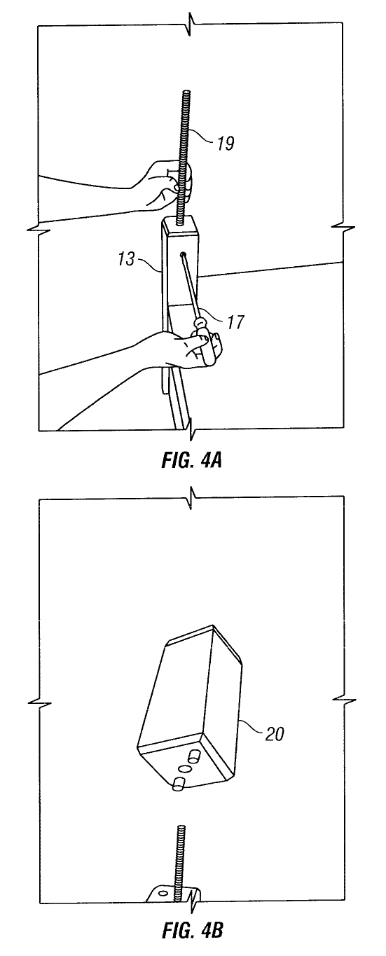

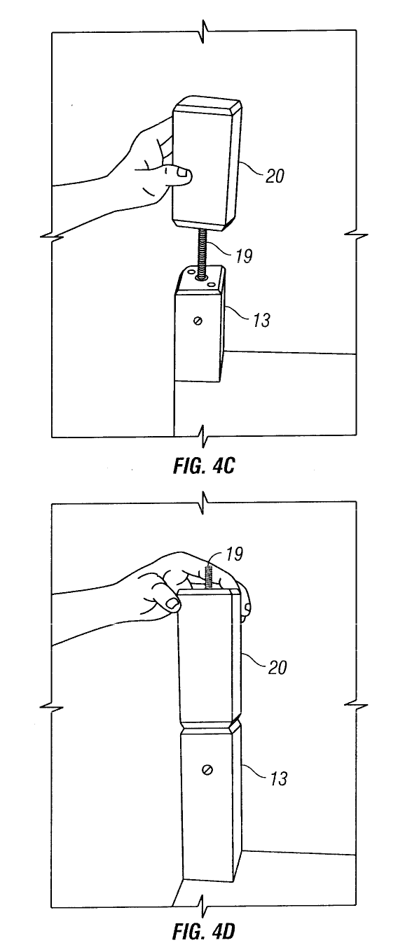

Referring now to FIG. 4, there is illustrated one non-limiting method of the disclosure for attaching height extension pieces to article 10 in order to convert article 10 from height H1 to height H2. First, tabletop 11 may be removed from base 12, and all thread 16 may be removed from base leg 13, and joint connector nut 18 may or may not be removed from base leg 13. Next, by use of a tool such as flathead screwdriver 17, joint connector nut 18 is properly positioned in connector nut receiving hole on one side of base leg 13, see FIG. 4A. All thread 19 may be then properly aligned with joint connector nut 18, and screwed into joint connector nut 18 until securely tightened, FIG. 4A. Height extension piece 20 may then be positioned over all thread 19 and secured into proper position, as shown in FIGS. 4B through 4D, by passing/sliding all thread 19 through the hole drilled through the length of extension piece 20. Extension piece 20 may be secured/held in proper alignment atop base leg 13 by any means known in the art including but not limited to dowels which connect base leg 13 and extension piece 20. The process illustrated in FIGS. 4A through 4D may then be repeated for each base leg 13.

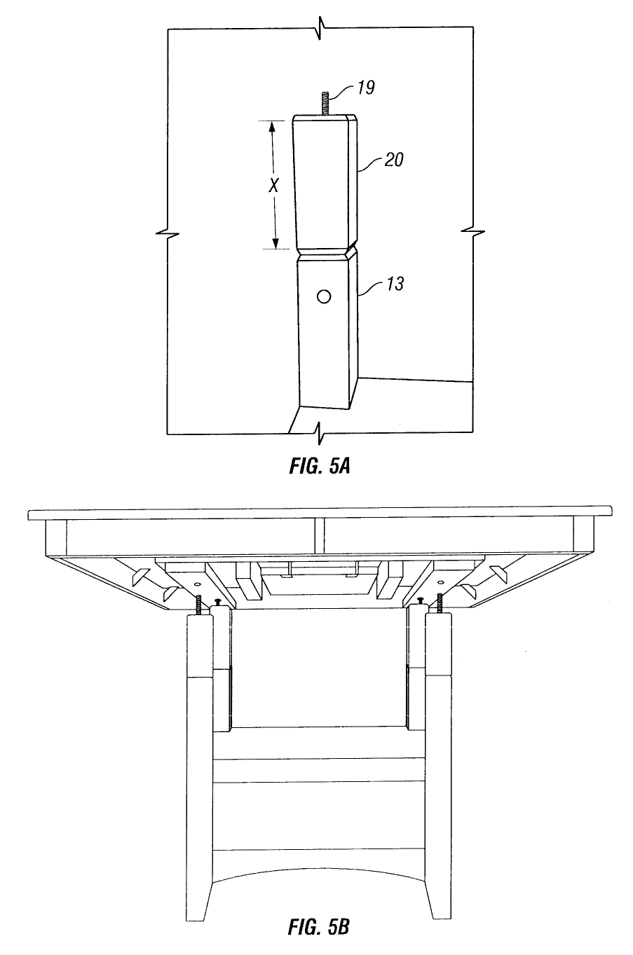

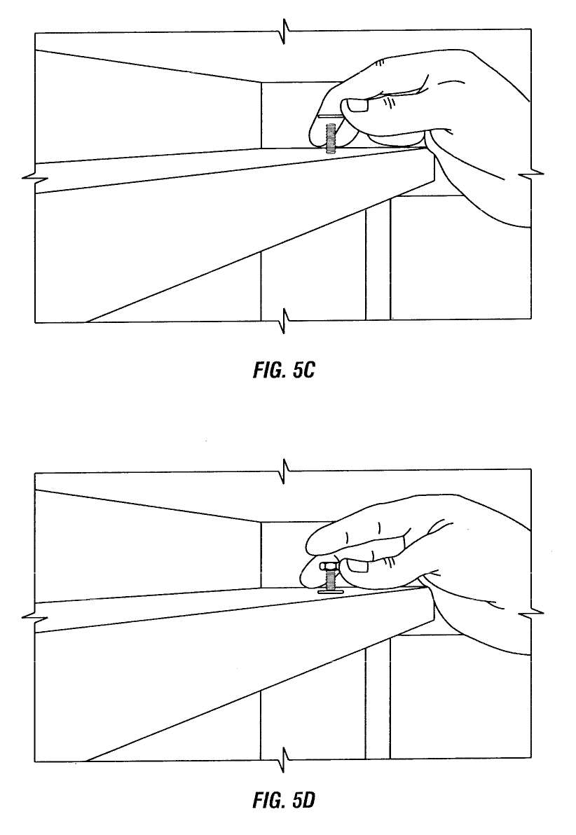

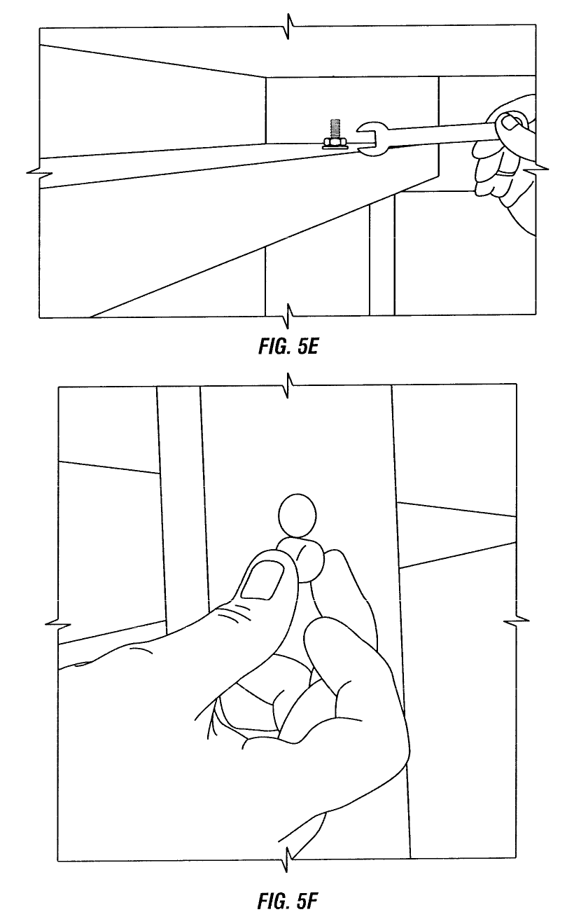

Referring now to FIG. 5A there is shown one of four base legs 13 of base 12 after attachment of height extension piece 20 atop each base leg 13 but prior to attachment of a tabletop, wherein all thread 19 extends from the top of extension piece 20. Tabletop 11 may then installed onto base 12 by aligning attachment holes in tabletop 11 with each all thread 19, shown in FIG. 5B. Tabletop 11 may then be secured to base 12 by any means known in the art. Shown in FIGS. 5C through 5E, a washer may be placed over each all thread 19, followed by attachment of a nut onto each all thread 19. FIG. 5F shows insertion of wooden plug 21 into a first receiving hole in one of four base legs 13. As mentioned previously, generally the plugs are removable.

FIG. 6 shows the height-converted article 10 having height H2, wherein H2=(H1+X), and wherein H1 is the height of the table prior to addition of height extension pieces onto the table base, and X is the length of the selected extension piece. In the non-limiting embodiment illustrated in the present figures, H1 is 30 inches, the X value of extension pieces 20 is 6 inches, H2 is 36 inches, each all thread 16 is 4 inches in length, and each all thread 19 is 10 inches in length.

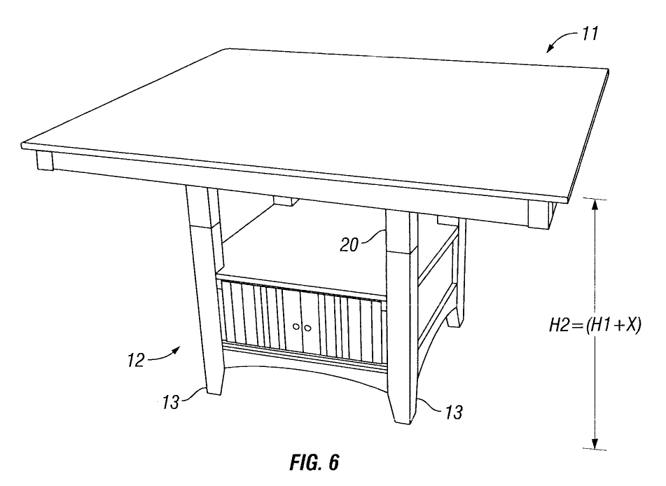

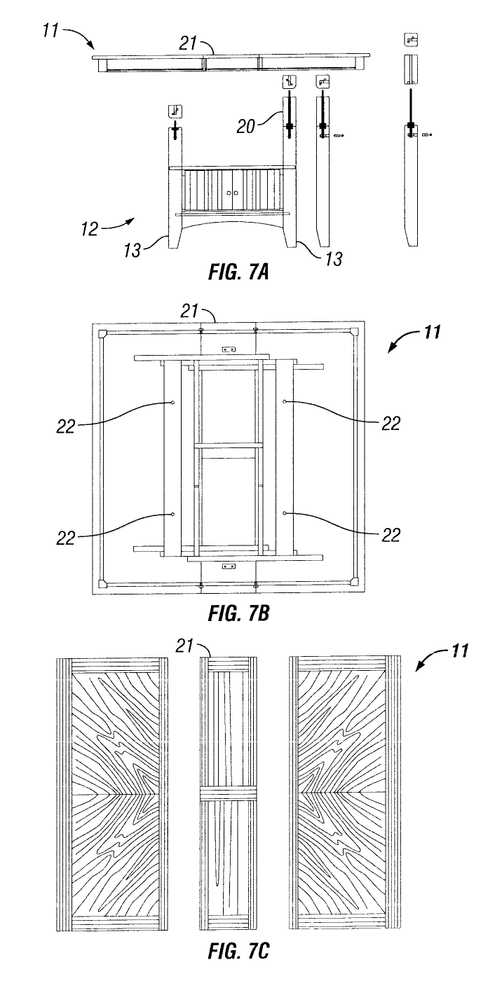

Referring now to FIGS. 7A and 7B and 7C, there are provided cross section front, cross section plan and top elevation views, respectively, of non-limiting article 10. FIG. 7A shows table base 12 comprising base leg 13 on the left having all thread 16 attached thereto, and base leg 13 on the right having all thread 19 and height extension piece 20 attached thereto. Tabletop 11 is shown in FIGS. 7A, 7B and 7C with table leaf 21 inserted therein. Also shown in FIG. 7B are four holes 22 used for affixing tabletop 11 atop table base 12 as discussed for FIGS. 2B and 5B. As stated previously, the tabletops utilized for tables of the present disclosure may be any type of tabletop known in the art and may have any shape.

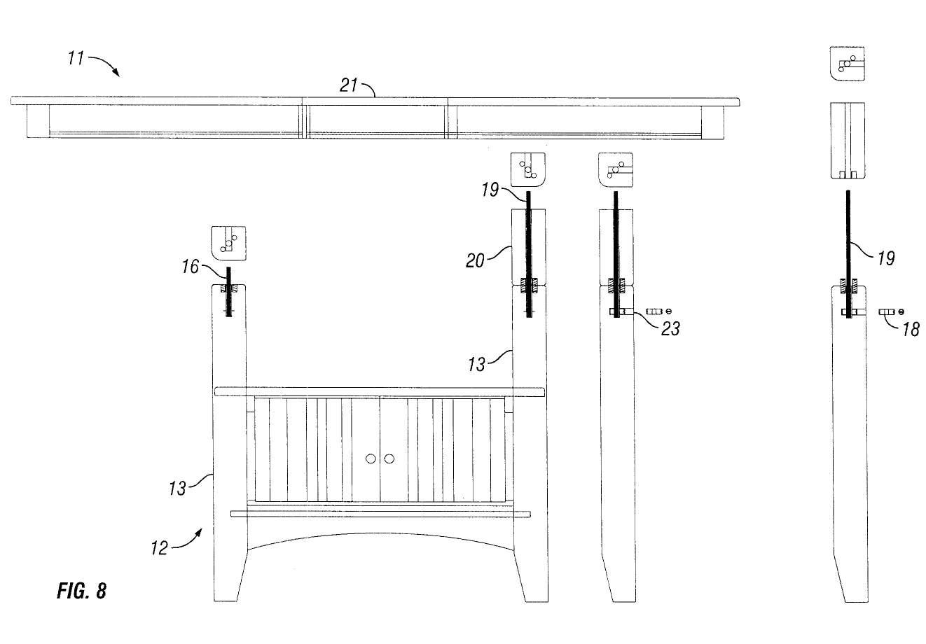

Referring now to FIG. 8 there is provided a cross section front view of non-limiting article 10 of the disclosure. FIG. 8 shows table base 12 comprising base leg 13 on the left having all thread 16 attached thereto, and base leg 13 on the right having all thread 19 and height extension piece 20 attached thereto. As indicated, all thread 16 is 4 inches in length, 5/16 of an inch in diameter, and has a per inch thread count of 18, and all thread 19 is 10 inches in length, 5/16 of an inch in diameter, and has a per inch thread count of 18. In other embodiments, the diameter, length and thread count may be any known in the art with selection being dependent at least upon the height of the extension piece, the diameter of the hole in the extension piece, and the joint connector nut. Tabletop 11 is shown in FIG. 8 with table leaf 21 inserted therein. The length of table leaf 21 is shown extending front to back relative to the front/doors of base 12. In other embodiments, tabletops may comprise an insertable leaf that when inserted into the tabletop extends side to side relative to the front/doors of base 12.

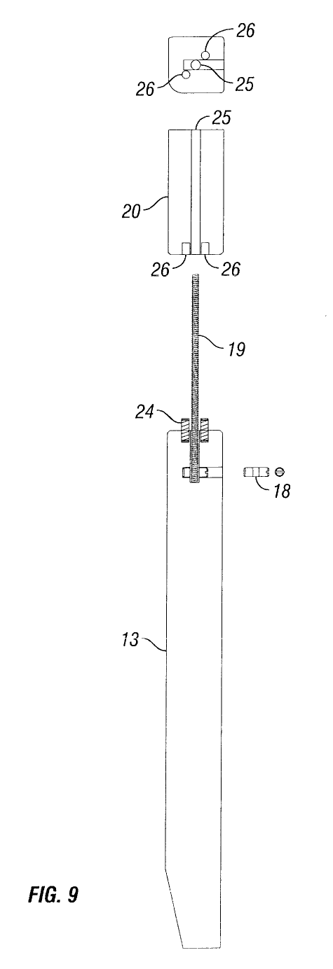

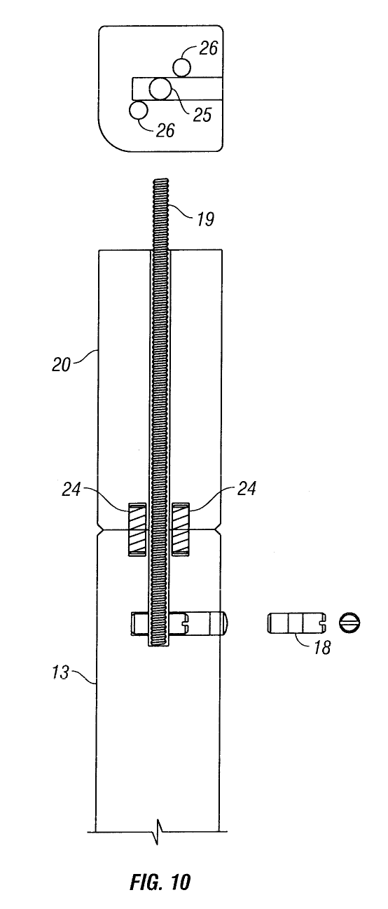

Referring now to FIGS. 9 and 10 there is shown one base leg 13 having height extension piece added thereto. In FIGS. 9 and 10, joint connector bolt 18 and all thread 19 are shown securely positioned within base leg 13. FIG. 9 shows extension piece 20 prior to being positioned on base leg 13, and illustrates longitudinal hole 25 through extension piece 20 into which all thread 19 may be positioned. Also shown are dowels 24 in base leg 13 which may be positioned within holes 26 in extension piece 20. In FIG. 10A, height extension piece 20 has been positioned atop base leg 13 by sliding piece 20 over all thread 19. Extension piece 20 may be secured in position atop base leg 13 by dowels 24. Also in FIG. 10, wood plug 23 has been inserted in base leg 13. FIGS. 9 and 10 show cross section top views of the top of extension piece 20 showing longitudinal hole 25 and dowel-receiving holes 26.

As stated previously in the disclosure, while the embodiment illustrated in the present figures shows height extension pieces affixed to a table base by means of all threads and dowels wherein the all thread is fitted through the interior of the extension piece, any fasteners and/or attachment means known in the art may be used herein. Other embodiments contemplate fasteners and/or connectors affixed to an exterior and/or a side surface of the height extension pieces and/or the table base. Even other embodiments contemplate fasteners and/or connectors having one member affixed to the table base and one member affixed to a height extension piece which are then interconnected and/or interlocked to one another.

Any one or more exterior and/or interior surfaces of the tables of the present disclosure may comprise any one or more protective and/or decorative finishes and/or treatments known in the art including surface liners, stain, paint, varnish, polyurethane, wax, oils, and any combinations thereof. With respect to finishes, the finish may be applied using any one or more technique known in the art, such as but not limited to, application of paint to result in an aged and/or distressed look. The tables of the disclosure may comprise any decorative features, elements, techniques, and/or designs known in the art including trim, hardware, inlay, etching, routed surfaces and/or edges, marquetry, parquetry, and all combinations thereof.

With respect to the material from which the tabletops, table bases and height extension pieces of the disclosure are manufactured, any one or more materials known in the art may be used including solid wood material, wood composite material, plywood materials, composites, polymers, ceramics, metals, and all combinations thereof. The tabletop, table base and height extension pieces may comprise the same type of material as one another, or may comprise different types of material. In some instances, the finish of the height extension pieces may be selected to match and/or compliment the finish of the table. With respect to wood, the wood may be any hardwood or softwood known in the art including, but not limited to, ash, beech birch, cherry, hickory, maple, oak, poplar, walnut, fir, and pine. Assembly of the articles may comprise any joinery methods, any hardware, glue compounds, and all combinations thereof, and the use of any methods known in the art for assembling furniture.

While the embodiment illustrated in the present figures comprises a cabinet style base comprising a storage area concealed by a pair of doors, the tables of the present disclosure may comprise any one or more elements/features known in the art such as, but not limited to, drawers, shelves, doors, storage compartments, power outlets/receptacles, phone jacks, data jacks, data ports, and computer ports. It is to be understood that articles of the disclosure may comprise any combination of any number of these elements/features. As known by one of skill in the art, any one or more of these elements may be mounted in a manner that allows the element to be positioned in more than one position. For example, any one or more drawers, shelves, doors, and/or storage compartments of the present articles may be mounted with guides/sliders thereby making them slidable/retractable.

The furniture of the present invention may comprise tables in the traditional sense, or may comprise cabinents, chests and the like, having a surface or top functioning as a table top, which table top may be adjusted according to the present invention. The articles of the present disclosure may comprise one or more storage compartments. The one or more of the storage compartments may be concealed and accessible by one or more doors. Each storage compartment may be used to store and/or organize any one or more of items. The one or more storage compartments may be any size and dimensions within the range of the dimensions of the table base. Each of the one or more storage compartments may be in an immobile, fixed position, or may be mounted by one or more guides/slides that enable the compartment to function as a “pull-out” compartment. Suitable guides/slides for pull-out storage compartments include all such mechanisms known in the art such as but not limited to slides comprising wood, plastic, metal and all combinations thereof, for example, wood on wood guides, and ball-bearing slides. Guide/slide selection may be dependent upon at least the intended weight-bearing capacity of the storage compartment.

Each storage compartment may comprise one or more shelves. Each of the one or more shelves may be mounted in an immobile, fixed position, or by one or more guides/slides that enable the shelf to function as a “pull-out” shelf. Suitable guides/slides for pull-out shelves include all such mechanisms known in the art such as but not limited to slides comprising wood, plastic, metal and all combinations thereof, for example, wood on wood guides, and ball-bearing slides. Guide/slide selection may be dependent upon at least the intended weight-bearing capacity of the shelf. For example, if it is desired that a shelf be capable of accommodating a heavy object, then generally a heavy duty guide/slide is selected such as, but not limited to, a heavy duty ball-bearing slide. The pull-out shelf may be slid forward horizontally by a user in order to facilitate the user's access to and/or use of the shelf, and/or items on the shelf. As known by one of skill in the art, the use of stoppers may be utilized if necessary to prevent the pull-out shelf from sliding completely off the guide/slide. For ease of mounting, generally the shelves utilized herein span the entire left to right distance of the storage compartment in which they are mounted.

Each of the one or more shelves, storage compartments, and/or storage areas may comprise a liner to protect and/or stabilize any items placed thereon. Suitable liners include all liners and materials known in the art. In one non-limiting embodiment, the liner is padded. In another non-limiting embodiment, the liner comprises neoprene. Generally the liner is applied to the surface of the shelf, storage compartment, and/or storage area upon which items may be placed and/or with which items may make contact. The shelves of the disclosure may comprise a rail or lip positioned at their outside edges to assist in preventing items from sliding off the shelf while being stored thereon.

As stated previously, each of the one or more storage compartments may be concealed and accessible by one or more doors. With respect to the one or more doors of the articles of the disclosure, the doors may be at any location provided the location allows for ease of operation and access to the doors. Thus, the one or more doors may be located on one or more of the following: an end/side, the back, the front, and any combination thereof. Generally, the one or more doors are located on the front. Each of the one or more of the doors may comprise a lock for security purposes. For simplicity and ease of operation, if an article of the disclosure comprises more than one lock, generally the locks are all keyed the same such that they are operable by a single key or a single combination. The locks utilized herein may be any suitable lock known in the art such as but not limited to a cam lock, a combination lock, cylinder lock. Generally the lock is located on and accessible from the front/face of the door.

With respect to the dimension of the doors, these are generally dependent at least upon the dimensions of body of the table base. In one embodiment, each door is approximately one-half the length of the body of the article. For doors present in a pair, each of the doors in the pair may or may not be of relatively equal dimensions to one another.

The doors may further comprise any features and/or hardware known in the art useful in facilitating the opening and the closing of a door such as, but not limited to, handles, recesses, knobs, clasps, door catches, magnetic door catches, locks, hinges, and all combinations thereof. As known by one of skill in the art, the doors may be mounted to the article in such a fashion that a user is able to open the doors then slide the doors into the storage compartment and thus out of sight and out of the way.

The article of the disclosure may comprise one or more drawers. The one or more drawers may be located at or on any part of the base that allows access to and utilization of the drawer. In one non-limiting embodiment, the one or more drawers are accessible from the front of the article. The one or more drawers may be located adjacent to the doors, and may be on the left side of the doors, the right side of the doors, or both. The one or more drawers may be located on the left or right end of the article and thus open to the left or the right, respectively. The one or more drawers may be used to store and/or organize any one or more of any type of item. The one or more drawers may be designed for specialized storage such as, but not limited to, designed to accommodate hanging letter and/or legal files. Any drawer slide mechanisms or “sliders” known in the art may be used herein including drawer sliders comprising wood, plastic, metal, and all combinations thereof. Selection of the type of drawer slider may be dependent upon at least the intended weight-bearing capacity of each drawer. For example, heavy-duty ball-bearing slides may be selected for mounting a drawer intended to store relatively heavy items.

Each of the one or more drawers may comprise a lock for security purposes. For simplicity and ease of operation, if an article of the disclosure comprises more than one lock, generally the locks are all keyed the same such that they are operable by a single key or a single combination. The locks utilized herein may be any type of lock suitable for use with articles of furniture such as but not limited to a cam lock, a combination lock, cylinder lock. For ease of operation, generally the lock is located on and accessible from the front/face of the drawer. Alternatively, in some embodiments the drawer lock may be located on and accessible from one of the sides of the drawer. Each drawer may comprise any type of handle, recess, notch, and/or knob useful in facilitating the opening and closing of the drawer. The depth and height dimensions of the drawer are dependent at least upon the dimensions of the body of the article. To maximize the storage space provided by the drawer, the drawer may be the maximally allowed depth and height dimensions provided by the body of the article. Generally the depth of the drawer is in the range of at least one-fifth the depth of the article and the full depth of the article. With respect to the width of the drawer, generally the drawer is between one-fourth and one-half of the length of the body of the article. In embodiments comprising more than one drawer, the more than one drawers may be in any configuration including but not limited to side by side, stacked atop one another and any combination thereof.

The articles may further comprise casters, and any combinations thereof, attached to or extending from the bottom of the article. As known by one of skill in the art, the use of casters provide enhanced mobility and allow an article to be easily moved from one position/location to another. Locking casters may be utilized in order to prevent unintentional movement of the article. As also known by one of skill in the art, casters may be hidden from view by use of any one or more design element known in the art including but not limited to trim and molding.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

All references cited herein, including articles, U.S. and foreign patents and patent applications, are specifically and entirely incorporated herein by reference.

What is claimed is:

1. An apparatus comprising:
a base comprising a body and legs;
a tabletop supported by said base; and
at least one height extension piece removably attached to said base.

2. The apparatus of claim 1 wherein said table is convertible between a first height and at least a second height, wherein said first and second heights are in the range of 12 to 60 inches.

3. The apparatus of claim 1 wherein said body of said base comprises a storage compartment.

4. The apparatus of claim 1, wherein the height extension pieces may differ by length, shape, exterior finish or design.

5. The apparatus of claim 4 wherein said base, tabletop and extension pieces each have a cross sectional shape selected independently from the group consisting of square, rectangular, round, oval, any regular geometric shape, and any irregular geometric shape.

6. The apparatus of claim 1 wherein said tabletop comprises a removable table leaf.

7. A system comprising:
a base comprising a body and legs;
a top surface panel positioned atop said base; and
a set of interchangeable height extension members.

8. The system of claim 7 wherein said base is convertible between a first height and at least a second height.

9. The system of claim 7 wherein the height extension members may differ by length, shape, exterior finish or design.

10. A method for converting the height of a table comprising the step of:
adding a height extension piece to a table.

11. The method of claim 10 wherein the height extension pieces may differ by length, shape, exterior finish or design.

12. A method for converting the height of a table having a height extension piece comprising the steps of:
removing the height extension piece from said table.

13. The method of claim 12, wherein the height extension pieces may differ by length, shape, exterior finish or design.

14. A method for converting the height of a table having a first height extension piece, comprising the steps of:
removing the first height extension piece; and
positioning a second height extension piece in place of the first height extension piece.

15. The method of claim 14, wherein the height extension pieces may differ by length, shape, exterior finish or design.

16. A method for converting the height of a table having a first height extension piece, comprising the step of:
attaching a second height extension piece in tandem to the first height extension piece.

17. The method of claim 16, wherein the height extension pieces may differ by length, shape, exterior finish or design.

18. A table sales system comprising
at least one display table unit on display in a display area;
a sales stock comprising at least one reserve table base unit and at least one reserve height extension piece.

19. The table sales system of claim 18, wherein there are at least 2 reserve table base units, and at least 2 reserve height extension pieces.

20. The table sales system of claim 18, wherein there are at least 3 reserve table base units, and at least 3 reserve height extension pieces.

21. The table sales system of claim 18, wherein there are at least 10 reserve table base units, and at least 4 height extension pieces.

22. The table sales system of claim 18, wherein at least a portion of the sales stock is positioned adjacent the display table unit.

23. The table sales system of claim 18, wherein at least a portion of the sales stock is positioned storage/warehouse space in proximity to the display area.

24. The table sales system of claim 18, wherein at least a portion of the sales stock is positioned at remote storage/warehouse space.

25. The table sales system of claim 18, wherein the height extension pieces may differ by length, shape, exterior finish or design.

26. A method for processing an order comprising the steps of:
receiving order for a table of a first description; and
filling the order with a base unit table and the necessary height extension piece to correspond to description.

27. The method of claim 26, wherein the description is in the form of a SKU number.
